(19) United States
(12) Patent Application Publication
(10) Pub. No.: US 2015/0032637 A1
(43) Pub. Date: Jan. 29, 2015

(54) CREATING IMAGE PRODUCT DESIGN BY DISTRIBUTED USERS IN A TRUE TEMPORAL PARALLEL FASHION

(71) Applicant: Shutterlfy, Inc., Redwood City`, CA (US)

(72) Inventors: Eric Koon, Sunnyvale, CA (US); Cuong Ta, Santa Clara, CA (US); Darshan Katrumane, Sunnyvale, CA (US)

(73) Assignee: Shutterlfy, Inc., Redwood City, CA (US)

(21) Appl. No.: 14/275,550

(22) Filed: May 12, 2014

Related U.S. Application Data
(60) Provisional application No. 61/858,200, filed on Jul. 25, 2013.

(51) Int. Cl. G06Q 10/10; B42D 15/02

(52) U.S. Cl. CPC G06Q 10/101; B42D 15/02
USPC 705/300

(57) ABSTRACT

A computer-implemented method includes allowing a first user to initiate a design of an image product on a first device, allowing the design of the image product to be shared to mobile devices operated by second users, receiving personalized messages comprising a plurality of pixels from the first user or the second users by a network-based image service system, storing personalized messages from the first user or the second users in different layers at a data center in the network-based image service system, concurrently broadcasting changes in values of the pixels to the first device and the mobile devices to allow an overlay of the personalized messages on the first device or the mobile devices, and incorporating the personalized messages into the design of the image product by the network-based image service system.

### TECHNICAL FIELD

This application relates to utilization of digital images, and more specifically, to the design and creation of products incorporating digital images.

### BACKGROUND OF THE INVENTION

Digital images captured by digital cameras can be stored in computers and viewed on electronic display devices. A user can upload digital images to a central network location provided by an image service provider such as Shutterfly, Inc. The user can store, organize, manage, edit, enhance, and share digital images at the central network location using a web browser or software tools provided by the service provider. A user can also design and order image-based products from the image service provider. The image-based products can include photo greeting cards, holiday cards, photo stationeries, photo books, photo calendars, photo prints, photo mugs, and photo T-shirts using image content provided by the user. The image-based products can be created for the user or as photo gifts for others. A high degree of personalization is desirable in the image-based products to make them memorable to the users or to the photo gift recipients.

The proliferation camera phones and tablet computers allows increasing number of users to take pictures, share photos, post photos online, and create personalized photo products or projects using mobile devices.

The creation of personalized image products, however, can take considerable amount of time and effort. In some occasions, it is desirable or necessary for several people to contribute to an image product. For example, a group of people may want or need to jointly sign or write comments on a get-well card, a baby-shower card, a wedding-gift card.

There is therefore a need for more convenient methods and tools to assist users to create personalized image projects, image products, and designs, on distributed computer devices, especially on mobile devices.

### SUMMARY OF THE INVENTION

The present application disclosed a novel computer-implemented method to facilitate a group of people to jointly personalize an image product such as a greeting card from distributed locations. The disclosed method is allows user to personalize an image product in a true “temporal parallel” manner. Each user can view other people's input concurrently as each pixel is being input by other users. The disclosed method is convenient and is very suitable for mobile devices such as smart phones and tablet computers.

In one general aspect, the present invention relates to a computer-implemented method for jointly creating a design of an image product. The method includes: allowing a first user to initiate a design of an image product on a first device; allowing the design of the image product to be shared to mobile devices operated by one or more second users; receiving personalized messages from the first user or the one or more second users by a network-based image service system, wherein the personalized messages comprise a plurality of pixels; storing personalized messages from the first user or the one or more second users in different layers at a data center in the network-based image service system; concurrently broadcasting, by the network-based image service system, changes in values of the pixels to the first device and the mobile devices, which allows an overlay of the personalized messages on the first device or the mobile devices as the pixels are input by the first user or the one or more second users; and incorporating the personalized messages from the first user or the one or more second users into the design of the image product by the network-based image service system.

Implementations of the system may include one or more of the following. The step of receiving personalized messages can include consecutively receiving the plurality of pixels in a first personalized message from the first user device, wherein the step of storing personalized messages can include storing each of the plurality of pixels in the first personalized message as each of the plurality of pixels is received from the first user device by the network-based image service system, wherein the step of concurrently broadcasting can include: broadcasting each of the plurality of pixels in the first personalized message as each of the plurality of pixels is received from the first user device by the network-based image service system. The step of receiving personalized messages can include: consecutively receiving the plurality of pixels in a second personalized message from the second user device, wherein the step of storing personalized messages can include: storing each of the plurality of pixels in the second personalized message as each of the plurality of pixels is received from the second user device by the network-based image service system, wherein the step of concurrently broadcasting can include: broadcasting each of the plurality of pixels in the second personalized message as each of the plurality of pixels is received from the second user device by the network-based image service system. The computer-implemented method can further include allowing the mobile devices to install an image application provided by the network-based image service system, wherein the image applications are configured to display the design of the image product on the mobile devices. The step of allowing the design of the image product to be shared can include sharing a network address to the mobile devices. The step of incorporating can include: overlaying the personalized messages in different layers in the data center to form a combined layer; and incorporating the personalized messages in the combined layer into the design of the image product. The personalized messages can include handwritten signatures, drawings, an artwork, or symbol, or handwritten messages. The design of the image product can define an area to receive the personalized messages. The computer-implemented method can further include allowing at least one of the first user and/or the one or more second users to edit, change, or delete the personalized messages respectively input by the first user and/or the second one or more second users, wherein pixels in the displayed personalized messages are concurrently changed on the first device or the mobile devices as the pixels are edited, changed, or deleted by the first user and/or the one or more second users. The image product can include a greeting card, a photo book, a stationery, a calendar, a photo mug, an image print, a photo magnet, a photo coaster, a photo mouse pad, or a poster. The image product can include a birthday card, a wedding-gift card, or a baby shower card. The mobile devices can include a smart phone, a tablet computer, or a laptop computer.

These and other aspects, their implementations and other features are described in detail in the drawings, the description and the claims.

### BRIEF DESCRIPTION OF THE DRAWINGS

FIG. 1 is a block diagram of a system for producing personalized image products, image designs, or image projects compatible with the present invention.

FIG. 2 illustrates an exemplified process that allows a group of users to jointly personalize an image product from distributed locations in accordance to the present invention.

FIG. 3 illustrates concurrent inputting and displaying of personalized information in an image product in a true “temporal parallel” manner.

FIG. 4 illustrates a multi-layer data structure for storing and displaying personalized information in an image product that is input by several users.

FIG. 5 illustrates a user device displaying personalized information in an image product input by a different user in a true “temporal parallel” manner.

FIG. 6 is another view of a multi-layer data structure for storing and displaying personalized information in an image product that is input by several users.

### DETAILED DESCRIPTION OF THE INVENTION

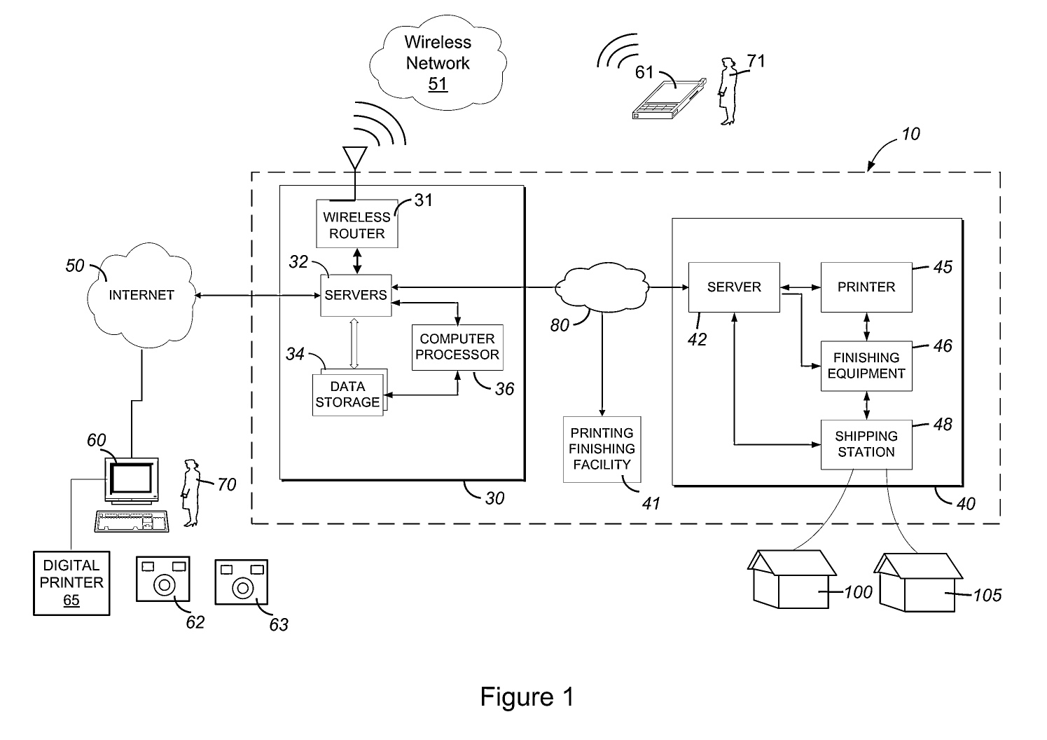

Referring to FIG. 1, a network-based imaging service system 10 can enable users 70, 71 to organize and share images via a wired network or a wireless network 51. The network-based imaging service system 10 is operated by an image service provider such as Shutterfly, Inc. Optionally, the network-based imaging service system 10 can also fulfill image products for the users 70, 71. The network-based imaging service system 10 includes a data center 30, one or more product fulfillment centers 40, 41, and a computer network 80 that facilitates the communications between the data center 30 and the product fulfillment centers 40, 41.

The data center 30 can include a server 32 for communicating and receiving input from the users 70, 71, a data storage device 34 for storing user data, image and design data, and a computer processor 36 for rendering images, organizing images, and processing orders. The user data can include account information, discount information, and order information associated with the user. A website can be powered by the servers 32 and can be accessed by the user 70 using a computer device 60 via the Internet 50, or by the user 71 using a wireless device 61 via the wireless network 51.

The network-based imaging service system 10 can provide products that require user participation in designs and personalization. Examples of these products include the personalized image products provided by Shutterfly, Inc. In the present disclosure, the term “personalized” refers to the information that is specific to the recipient, the user, the gift product, and the occasion, which can include personalized content, personalized text messages, personalized images, and personalized designs that can be incorporated in the image products. The content of personalization can be provided by a user or selected by the user from a library of content provided by the service provider. The term “personalized information” can also be referred to as “individualized information” or “customized information”.

Personalized image products can include users' photos, personalized text, personalized designs, and content licensed from a third party. Examples of personalized image products may include photo books, personalized greeting cards, photo stationeries, photo or image prints, photo posters, photo banners, photo playing cards, photo T-shirts, photo mugs, photo aprons, photo magnets, photo mouse pads, a phone case, a case for a tablet computer, photo key-chains, photo collectors, photo coasters, photo banners, or other types of photo gift or novelty item. Photo book generally refers to as bound multi-page product that includes at least one image on a book page. Photo books can include photo albums, scrapbooks, bound photo calendars, or photo snapbooks, etc. The image products each can include a single page or multiple pages. Each page can include one or more images, text, and design elements. Some of the images may be laid out in an image collage.

The user 70 or her family may own multiple cameras 62, 63. The user 70 transfers images from cameras 62, 63 to the computer device 60. The user 70 can edit, organize images from the cameras 62, 63 on the computer device 60. The computer device 60 can be in many different forms: a personal computer, a laptop, or tablet computer, a mobile phone etc. The camera 62 can include an image capture device integrated in or connected with in the computer device 60. For example, laptop computers or computer monitors can include built-in camera for picture taking The user 70 can also print pictures using a printer 65 and make image products based on the images from the cameras 62, 63. The cameras 62, 63 can include a digital camera, a camera phone, a video camera capable of taking motion and still images, a laptop computer, or a tablet computer.

The images from the cameras 62, 63 can also be uploaded to the server 32 to allow the user 70 to organize and render images at the website, share the images with others, and design or order image product using the images from the cameras 62, 63. The wireless device 61 can include a mobile phone, a tablet computer, or a laptop computer, etc. The wireless device 61 can include a built-in camera (e.g. in the case of a camera phone). The pictures taken by the user 71 using the wireless device 61 can be uploaded to the data center 30. If users 70, 71 are members of a family or associated in a group (e.g. a soccer team), the images from the cameras 62, 63 and the mobile device 61 can be grouped together to be incorporated into an image product such as a photo book, or used in a blog page for an event such as a soccer game.

The creation of personalized image products, however, can take considerable amount of time and effort. In some occasions, several people may want to contribute to a common image product. For example, a group of people may want or need to jointly sign their names, and hand write comments on a get-well card, a baby-shower card, a wedding-gift card. The group of people may be at different locations. In particular, it will be desirable to enable the group of people to quickly write their names and personal messages in the common image product using mobile devices.

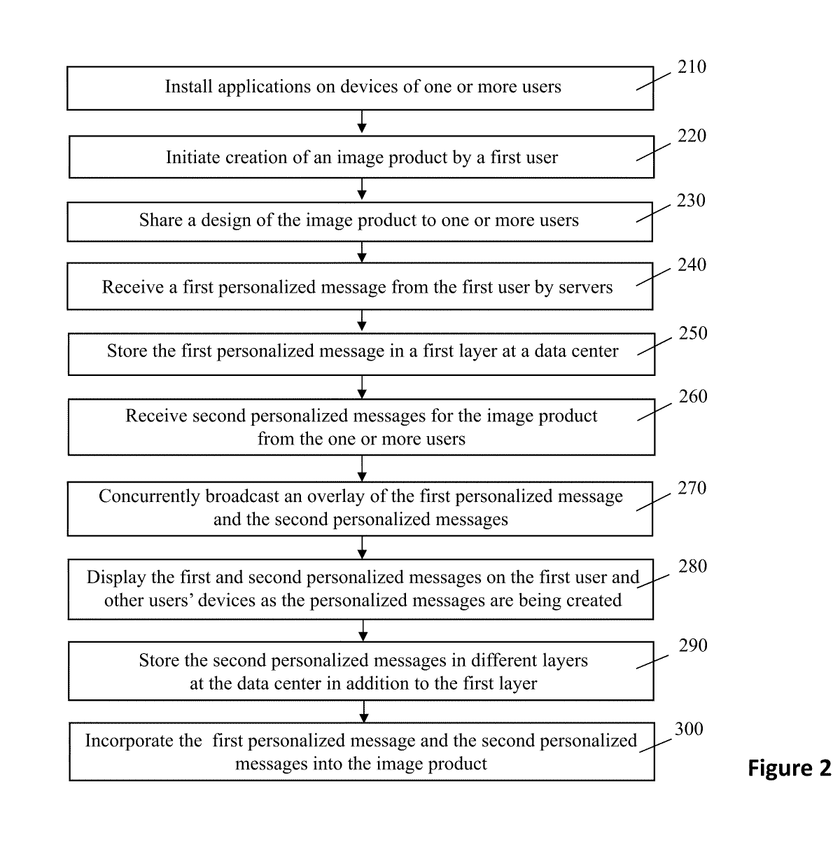

In some embodiments, referring to FIGS. 2-6, an application can optionally be installed on devices of one or more users in a group (step 210). The application can be provided by the image service provider. An example of such application is a mobile application for mobile devices. In some cases, a general-purpose application such as a web browser can be used for viewing and inputting to image product design, as described below.

A first user initiate the creation of an image product (step 220) on the first device operated by the first user. The first user may use a mobile device (e.g. the wireless device 61 in FIG. 1) such as a smart phone that is installed with a mobile application provided by a network-based imaging service system (e.g. 10 in FIG. 1) operated by an image service provider such as Shutterfly, Inc.

It should be noted that the devices operated by the first and other users can include mobile devices such as smart phones, tablet computers, laptop computers, digital personal assistant, etc., as well as desktop computers.

As stated above, the image product can include hardcopy image products such as greeting card, a photo book, a stationery, a poster, etc. The image product design can also include digital presentations such as a web page, a blog page, a portion of a photo story, etc. The image product design can include printed text, photos, background, and other design elements. In some embodiments, the image product design may include a free-form area dedicated for receiving handwritten signatures and comments, drawings, and artistic renderings from different users. In some embodiments, the design of the image product allows users to enter their input anywhere on the page layouts of the image products, including overlaying on printed (or typed) messages, photos, background pattern or image, and other design elements.

The design of the image product initiated by the first user is shared to other users (step 230) in order to receive input from the other users. The sharing is conducted via a network and can take different forms such as email, electronic texting, short message, etc. A network address (or a web address) can be embedded in the message for other users to access the image product design.

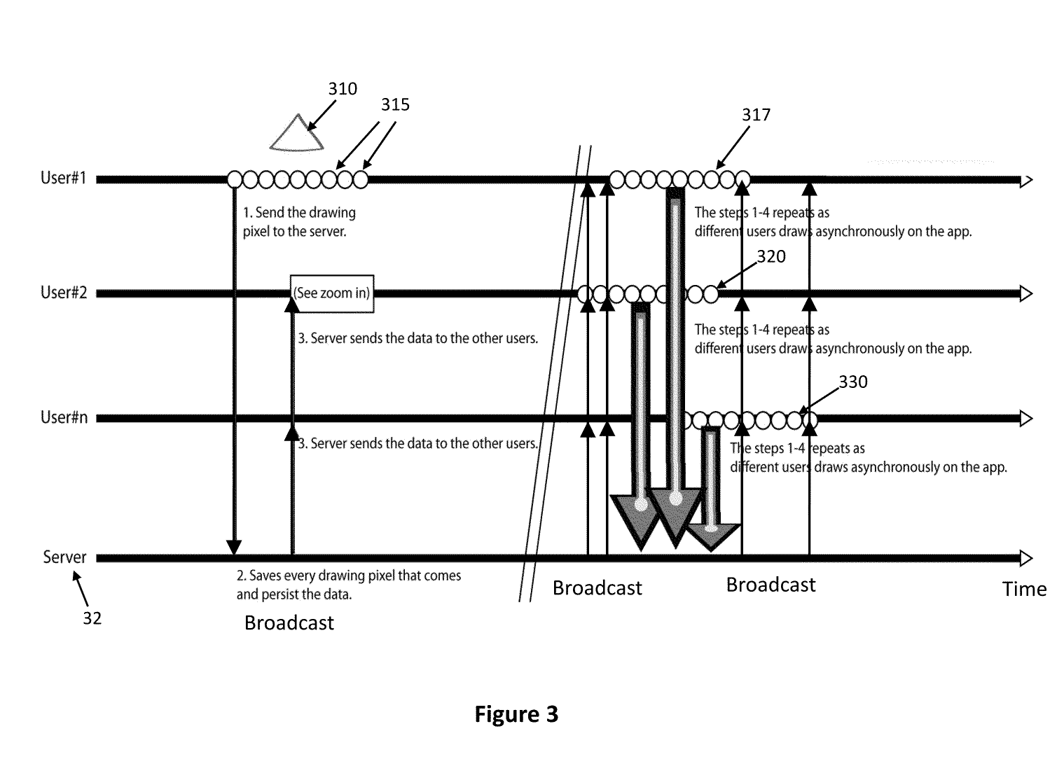

FIG. 3 illustrates concurrent inputting and displaying of personalized information in an image product in a true “temporal parallel” manner. Activities on several user devices and the server are illustrated along time in the horizontal axis. The first user can enter a first personalized message 310 such as a handwritten signature, a drawing, a symbol such as a happy face, a star, a bundle of flowers, etc., or a handwritten message. The first personalized message 310 is represented by a plurality of pixels 315.

The first personalized message 310 comprising the pixels 315 are received by the servers 32 (also in FIG. 1) (step 240).

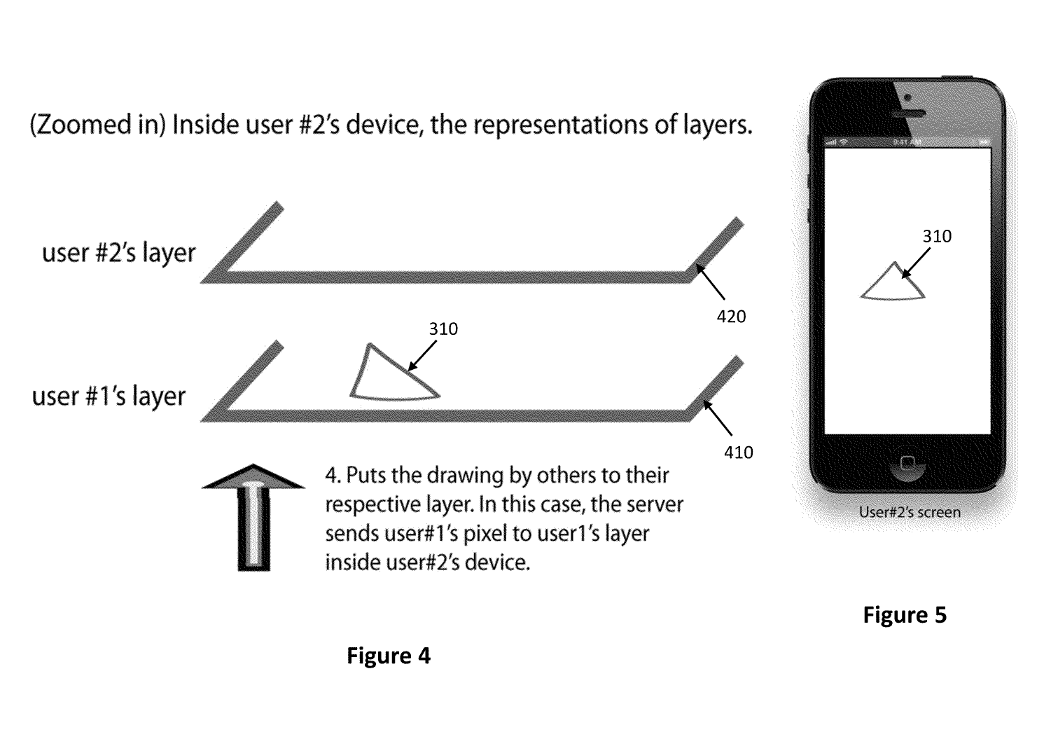

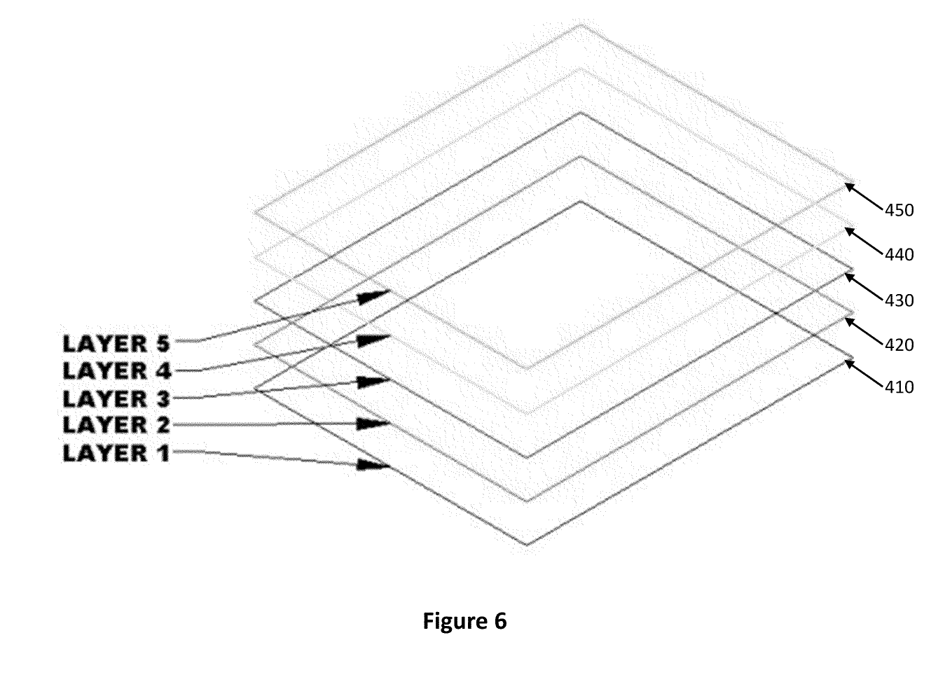

The first personalized message 310 comprising the pixels 315 are stored in a first layer 410 (FIGS. 4, 6) at a data center (30, FIG. 1) (step 250). The pixels 315 are defined by pixel positions (or coordinates) and pixel values. Using dedicated application (e.g. mobile apps) or general purpose applications (such as web browser), the first and other users can view the image product design in a same design environment. The first personalized message 310 is sent from the server 32 to other user devices to allow the pixels 315 to be displayed in real time in the same design environment.

The other users can input second personalized messages respectively comprising pixels 320, 330 into the design of the image product (step 260) using different devices operated by the other users. The second personalized messages can include handwritten signatures, drawings, or handwritten messages, which are expressed in pixels defined by pixel positions (or coordinates) and pixel values. For example, the users (user #1, user #2 . . . , user #N in FIG. 3) may jointly sign names and write congratulation messages on a birthday card, a wedding-gift card, or a baby shower card. For example, a birthday card may be signed with many messages and colorful artwork by many children, grandchildren, even great grandchildren, and other relatives. The pixels 320, 330 carrying the different personalized messages from different user devices can be stored in different layers 410-450, etc.

As shown in FIG. 3, as each of the users enters each pixel (as indicated by the small open circles along different time lines for the input sessions of the different users) on their respective devices, the change in the pixel value is continuously transmitted to the servers 32 in the data center (30, FIG. 1).

As soon as the server 32 receives values of pixels 317, 320, 330 from different user devices, the servers 32 concurrently broadcast the changes in pixel values at these pixels to all users' devices without waiting for the completion of individual messages (step 270). In other words, the broadcasting by the server occurs while pixels 317, 320, 330 are still being input but before the personal messages are finished.

As the pixels of the messages are being created on different devices, the servers 32 enables the first personalized message and the second personalized messages to be overlaid and displayed on the devices in the group of users including the first user and the other users (step 280). For example, as shown in FIGS. 4 and 5, a first personalized message 310 such as a drawing, an artwork, or symbol drawn by the user is stored in a first layer at the data center (30 in FIG. 1) and concurrently broadcasted to, displayed at, or stored in a true temporal parallel fashion on the second user's device. It should be noted that the first personalized message 310 are not completed, the portion of the pixels that are entered in the first user's device are sent to the server 32 (FIGS. 1, 3) and broadcasted to the second user's device. The servers 32 (FIGS. 1, 3) can collapse all the layers and overlay input from different users and display the overlay image on each of the devices. The overlay image progressively gains in new pixel values as each of the users makes his/her input.

Each of the users can change, edit, and remove his or her own inputs. That is, pixel values in the personalized messages can increase or decrease. In that processes, the pixels in the personalize messages can be gradually removed (i.e. whited out) or changed, and made viewable, similar to the descriptions above, by all users in a true temporal parallel fashion.

The second personalized messages are stored in different layers 420-450 (FIGS. 4, 6) at the data center in addition to the first layer (step 290). The first personalized message in the layer 410 and the second personalized messages in layers 410-450 can be overlaid on top of each other to form a combined layer. The combined layer of personalized messages is incorporated into the image product (step 300) by the server 32 or the computer processors (36, FIG. 1). The first user can finalize and edit the image product on his or her device.

The first user or other users can order the making of a physical product based on the design of the image product, which can be fulfilled by the printing and finishing facilities (40 and 41, FIG. 1). A recipient can receive the physical product with messages from the users at locations 100, 105 (FIG. 1). The recipient may also receive a digital version of the design of the image product over the Internet (50, FIG. 1) and/or a wireless network (51, FIG. 1). For example, the recipient can receive, on her mobile phone, an electronic version of a greeting card signed by handwritten signatures from her family members.

It should be noted that the above disclosed true “temporal parallel” application is different from conventional real time applications in web-based coauthoring and web blog postings. In these conventional “real time” applications, the message entered by a user is normally a line of text. The message is sent to a server after the user presses “enter” after line of text is finished, or after the user presses “send” after a line or a paragraph of text is submitted. The text entered is received by a server and posted on a web page for other user(s) to see. In these conventional “real time” applications, an image submitted by a user is first uploaded to a server as a file, and then the whole image posted on a web page by the server.

It should be understood that the presently disclosed systems and methods can be compatible with different devices and image products or applications other than the examples described above.

What is claimed is:

1. A computer-implemented method for jointly creating a design of an image product, comprising:
allowing a first user to initiate a design of an image product on a first device;
allowing the design of the image product to be shared to mobile devices operated by one or more second users;
receiving personalized messages from the first user or the one or more second users by a network-based image service system, wherein the personalized messages comprise a plurality of pixels;
storing personalized messages from the first user or the one or more second users in different layers at a data center in the network-based image service system;
concurrently broadcasting, by the network-based image service system, changes in values of the pixels to the first device and the mobile devices, which allows an overlay of the personalized messages on the first device or the mobile devices as the pixels are input by the first user or the one or more second users; and
incorporating the personalized messages from the first user or the one or more second users into the design of the image product by the network-based image service system.

2. The computer-implemented method of claim 1, wherein the step of receiving personalized messages comprises:
consecutively receiving the plurality of pixels in a first personalized message from the first user device,
wherein the step of storing personalized messages comprises:
storing each of the plurality of pixels in the first personalized message as each of the plurality of pixels is received from the first user device by the network-based image service system,
wherein the step of concurrently broadcasting comprises:
broadcasting each of the plurality of pixels in the first personalized message as each of the plurality of pixels is received from the first user device by the network-based image service system.

3. The computer-implemented method of claim 1, wherein the step of receiving personalized messages comprises:
consecutively receiving the plurality of pixels in a second personalized message from the second user device,
wherein the step of storing personalized messages comprises:
storing each of the plurality of pixels in the second personalized message as each of the plurality of pixels is received from the second user device by the network-based image service system,
wherein the step of concurrently broadcasting comprises:
broadcasting each of the plurality of pixels in the second personalized message as each of the plurality of pixels is received from the second user device by the network-based image service system.

4. The computer-implemented method of claim 1, further comprising:
allowing the mobile devices to install an image application provided by the network-based image service system, wherein the image applications are configured to display the design of the image product on the mobile devices.

5. The computer-implemented method of claim 1, wherein the step of allowing the design of the image product to be shared comprises sharing a network address to the mobile devices.

6. The computer-implemented method of claim 1, wherein the step of incorporating comprises:
overlaying the personalized messages in different layers in the data center to form a combined layer; and
incorporating the personalized messages in the combined layer into the design of the image product.

7. The computer-implemented method of claim 1, wherein the personalized messages comprise handwritten signatures, drawings, an artwork, or symbols, or handwritten messages.

8. The computer-implemented method of claim 1, wherein the design of the image product defines an area to receive the personalized messages, wherein the step of incorporating the personalized messages comprises placing the personalized messages in the area in the design of the image product.

9. The computer-implemented method of claim 1, further comprising:
allowing at least one of the first user to edit, change, or delete the personalized messages respectively input by the first user and/or the one or more second users, wherein pixels in the displayed personalized messages are concurrently changed on the first device and the mobile devices as the pixels are edited, changed, or deleted by the first user.

10. The computer-implemented method of claim 1, further comprising:
allowing the one or more second users to edit, change, or delete the personalized messages respectively input by the first user and/or the one or more second users, wherein pixels in the displayed personalized messages are concurrently changed on the first device and the mobile devices as the pixels are edited, changed, or deleted by the one or more second users.

11. The computer-implemented method of claim 1, wherein the image product includes a greeting card, a photo book, a stationery, a calendar, a photo mug, an image print, a photo magnet, a photo coaster, a photo mouse pad, or a poster.

12. The computer-implemented method of claim 11, wherein the image product includes a birthday card, a wedding-gift card, or a baby shower card.

13. The computer-implemented method of claim 1, wherein the mobile devices include a smart phone, a tablet computer, or a laptop computer.
